(19) United States
(12) Patent Application Publication
(10) Pub. No.: US 2025/0336033 A1
(43) Pub. Date: Oct. 30, 2025

(54) CONTENT PROCESSING TOOL FOR UPSCALING MEDIA CONTENT

(71) Applicant: Microsoft Technology Licensing, LLC, Redmond, WA (US)

(72) Inventors: Oren ISTRIN, Tel-Aviv (IL); Roei MENASHOF, Netanya (IL); Ori LASLO, Rehovot (IL); Darina BAL, Ramat Gan (IL)

(73) Assignee: Microsoft Technology Licensing, LLC, Redmond, WA (US)

(21) Appl. No.: 18/650,447

(22) Filed: Apr. 30, 2024

(51) Int. Cl. G06T 3/4046

(52) U.S. Cl. CPC G06T 3/4046

(57) ABSTRACT

Systems and methods for upscaling a content using an upscaling model are provided. In particular, a computing device may determine an output display resolution of a visual display adapted to display the content, determine an input resolution of the content to be requested based on the display resolution and an upscaling factor, determine a tile size of a tile of the content to be processed by the upscaling model, select the upscaling model from a plurality of upscaling models to be used for upscaling the content based on the tile size and the upscaling factor, in response to the receipt of the content according to the input resolution, convert the content to enhance the resolution of the content using the upscaling model, and render the converted content on the visual display.

### BACKGROUND

With the proliferation of electronic devices and associated diverse applications, optimizing system performance has become increasingly crucial. For example, streamlining high-resolution media content generally requires a large amount of network resources and bandwidth to effectively deliver the media content to users. Reducing latency and memory usage is useful for providing the users with a seamless and responsive experience. However, as quality of media content and performance demands increase, achieving optimal performance without compromising on accuracy and visual quality remains challenging.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In accordance with examples of the present disclosure, a content processing tool is configured to receive media content from a content server and upscale the media content to be displayed in accordance with a resolution and an aspect ratio of a visual display. Typically, the media content is fragmented and encoded at the content server to reduce memory storage consumption and transmission latency. When the media content is received, a decoder of the content processing tool decodes the media content and outputs macroblocks to a memory region rendered for a buffer, which are then fed into an upscaling model tile-by-tile to upscale the media content to be displayed on the visual display. The upscaling model is trained using a super-resolution algorithm for a particular input tile size and an upscaling factor. For example, the upscaling model is a deep neural network (DNN), a convolutional neural network (CNN), a deep convolutional neural networks (DCNN), other type of machine learning models, or a combination of models.

However, since the macroblocks are generated in a row-major order, it is not optimized for the upscaling model processing (e.g., the super resolution processing). In order for the upscaling model to begin processing a first tile, the upscaling model needs to wait for a first few lines of the macroblocks to be generated until a total number of rows of macroblocks is equal to a height of a defined tile. In other words, there is an idle time period where the upscaling model waits for each row of tiles to be generated and stored in the buffer memory between the decoder and the upscaling model, which adds latency and memory consumption. Accordingly, the content processing tool is configured to optimize an input tile size of an upscaling model to increase efficiency and performance of the upscaling model while reducing latency and memory consumption in a display pipeline.

In accordance with at least one example of the present disclosure, a method for upscaling a content using an upscaling model is provided. The method may include determining an output display resolution of a visual display adapted to display the content, determining an input resolution of the content to be requested based on the display resolution and an upscaling factor, and determining a tile size of a tile of the content to be processed by the upscaling model. The tile size indicates a number of pixels and an aspect ratio of the tile, and the tile is a segment of the content to be processed by the upscaling model. The method may further include selecting the upscaling model from a plurality of upscaling models to be used for upscaling the content based on the tile size and the upscaling factor, each upscaling model being trained with a particular tile size and a particular upscale factor for increasing the resolution of the content, in response to receiving the content according to the input resolution, converting the content to enhance the resolution of the content using the upscaling model, and rendering the converted content on the visual display.

In accordance with at least one example of the present disclosure, a computing device for upscaling a content using an upscaling model is provided. The computing device may include a processor and a memory having a plurality of instructions stored thereon that, when executed by the processor, causes the computing device to determine an output display resolution of a visual display adapted to display the content, determine an input resolution of the content to be requested based on the display resolution and an upscaling factor, determine a tile size of a tile of the content to be processed by the upscaling model, the tile size indicating a number of pixels and an aspect ratio of the tile, and the tile being a segment of the content to be processed by the upscaling model, select the upscaling model from a plurality of upscaling models to be used for upscaling the content based on the tile size and the upscaling factor, each upscaling model being trained with a particular tile size and a particular upscale factor for increasing the resolution of the content, in response to the receipt of the content according to the input resolution, convert the content to enhance the resolution of the content using the upscaling model, and render the converted content on the visual display.

In accordance with at least one example of the present disclosure, a non-transitory computer-readable medium storing instructions for upscaling a content using an upscaling model is provided. The instructions when executed by one or more processors of a computing device, cause the computing device to determine an output display resolution of a visual display adapted to display the content, determine an input resolution of the content to be requested based on the display resolution and an upscaling factor, determine a tile size of a tile of the content to be processed by the upscaling model, the tile size indicating a number of pixels and an aspect ratio of the tile, and the tile being a segment of the content to be processed by the upscaling model, select the upscaling model from a plurality of upscaling models to be used for upscaling the content based on the tile size and the upscaling factor, each upscaling model being trained with a particular tile size and a particular upscale factor for increasing the resolution of the content, in response to the receipt of the content according to the input resolution, convert the content to enhance the resolution of the content using the upscaling model, and render the converted content on the visual display.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts a block diagram of an example overview of a content processing pipeline in which a content processing tool may be implemented in accordance with examples of the present disclosure;

FIG. 2 depicts a block diagram of an example of an operating environment in which a content processing tool may be implemented in accordance with examples of the present disclosure;

FIGS. 3A and 3B depict a flowchart of an example method of upscaling media content using an upscaling model in accordance with examples of the present disclosure;

FIGS. 4A and 4B illustrate upscaling of a single frame of the media content using a square input tile size for an upscaling model in accordance with examples of the present disclosure;

FIGS. 5A and 5B illustrate upscaling of a single frame of the media content using an elongated rectangle input tile size for an upscaling model in accordance with examples of the present disclosure;

FIGS. 6A and 6B depict how different input tile sizes affects buffer memory consumption in accordance with examples of the present disclosure;

FIG. 7 is a block diagram illustrating example physical components of a computing device with which aspects of the disclosure may be practiced;

FIG. 8 is a simplified block diagram of a computing device with which aspects of the present disclosure may be practiced; and

FIG. 9 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

With the proliferation of electronic devices and associated diverse applications, optimizing system performance has become increasingly crucial. For example, streamlining high-resolution media content generally requires a large amount of network resources and bandwidth to effectively deliver the media content to users. Reducing latency and memory usage is vital for providing the users with a seamless and responsive experience. However, as quality of media content and performance demands increase, it may be challenging to achieve optimal performance without compromising on accuracy and visual quality.

In accordance with examples of the present disclosure, a content processing tool is configured to receive media content from a content server and upscale the media content to be displayed in accordance with a resolution and an aspect ratio of a visual display. Typically, the media content is fragmented and encoded at the content server to reduce memory storage consumption and transmission latency. When the media content is received, a decoder of the content processing tool decodes the media content and outputs macroblocks to a memory region rendered for a buffer, which are then fed into an upscaling model tile-by-tile to upscale the media content to be displayed on the visual display. The upscaling model is trained using a super-resolution algorithm for a particular input tile size and an upscaling factor. For example, the upscaling model is a deep neural network (DNN), a convolutional neural network (CNN), a deep convolutional neural networks (DCNN), other type of machine learning models, or a combination of models.

However, since the macroblocks are generated in a row-major order, it is not optimized for the upscaling model processing (e.g., the super resolution processing). In order for the upscaling model to begin processing a first tile, the upscaling model needs to wait for a first few lines of the macroblocks to be generated until a total number of rows of macroblocks is equal to a height of a defined tile. In other words, there is an idle time period where the upscaling model waits for each row of tiles to be generated and stored in the buffer memory between the decoder and the upscaling model, which adds latency and memory consumption. Accordingly, the content processing tool is configured to optimize an input tile size of an upscaling model to increase efficiency and performance of the upscaling model while reducing latency and memory consumption in a display pipeline. To do so, parameters, such as a size of a decoder output macroblock, a session configuration, the performance of the upscaling model, system limitations, and/or memory and latency requirements may be considered to determine the optimal balance between the efficiency and performance of the upscaling model and the memory and latency consumption and, thereby, finding the optimal input tile size of the upscaling model.

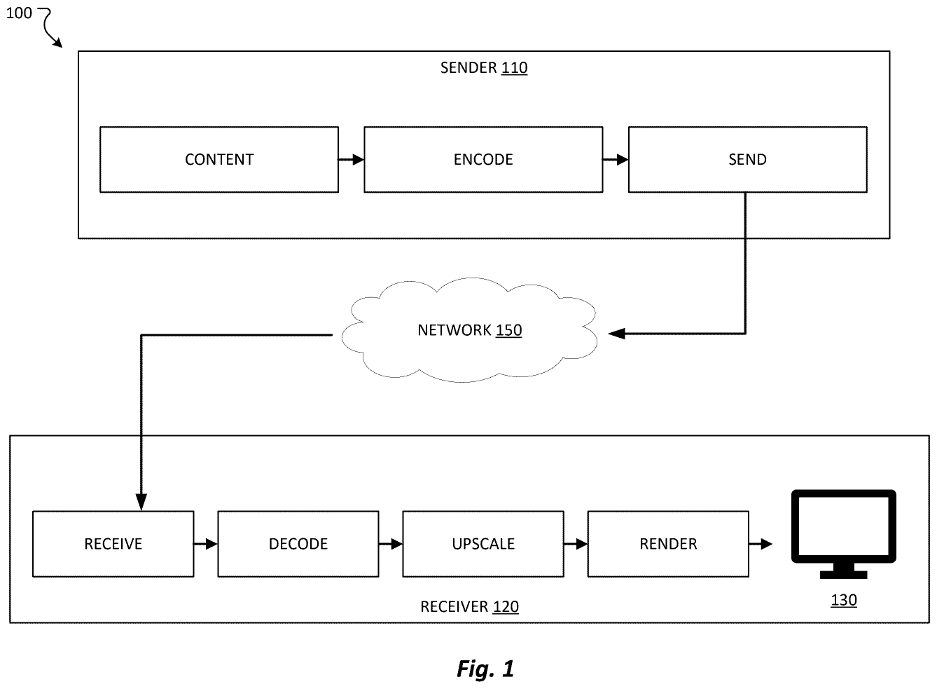

Referring now to FIG. 1, a block diagram of an example overview of a content processing pipeline 100 in which a content processing tool may be implemented in accordance with examples of the present disclosure is provided. For example, the content processing 100 may be utilized for streaming media content from a sender 110 to a receiver 120 and displaying the media content on a visual display 130 in accordance with a resolution and an aspect ratio of the visual display 130 using an upscaling model. For example, the receiver 120 is a client computing device where the content processing tool is being executed to display the media content on the visual display 130 that is communicatively coupled to the receiver 120. The sender 110 is a content server that stores or otherwise has access to the media content requested by the receiver 120.

The sender 110 is configured to deliver media content to the receiver 120 who requested the media content. For example, the media content may be one or more images, pictures, photos, videos, and/or audios. To do so, the sender 110 retrieves the requested media content from storage and encodes the media content. For example, the media content is fragmented and compressed to reduce memory storage consumption and transmission latency. In some embodiments, the media content may further be encrypted for added security. The encoded media content is then transmitted to the receiver 120 via a network 150. The network 150 may include any kind of computing network including, without limitation, a wired or wireless local area network (LAN), a wired or wireless wide area network (WAN), and/or the Internet.

Once the encoded media content is received by the receiver 120 (e.g., the content processing tool 230), the receiver 120 is configured to decode the encoded media content. For example, if the encoded media content is compressed, the receive 120 decompresses the compressed media content to output macroblocks of decompressed media content and stores the macroblocks on a buffer memory. In some embodiments, if the encoded media content is further encrypted by the sender 110, the receiver 120 decrypts the encrypted compressed content and decompresses the decrypted compressed content into macroblocks of decompressed content. In certain embodiments, if the sender 110 encrypted the media content then compressed the encrypted content, the receiver 120 decompresses then decrypts the decompressed encrypted content into macroblocks.

Subsequently, the receiver 120 upscales the media content tile-by-tile using the upscaling model to generate the upscaled media content according to a resolution and an aspect ratio of the visual display 130. For example, the upscaling model is a deep neural network (DNN), a convolutional neural network (CNN), a deep convolutional neural networks (DCNN), other type of machine learning models, or a combination of models.

Typically, the media content received from the sender 110 is fragmented, compressed, and in a low-resolution to reduce memory storage consumption and transmission latency. Accordingly, the upscaling model is adapted to increase the resolution of the media content received from the sender 110 by a factor of a predetermined upscaling factor (e.g., 4× or more). The receiver 120 may include a plurality of upscaling models, where each upscaling model is trained for a particular size of an input tile and an upscaling factor. The tile is a segment of the content to be inputted and processed by the upscaling model. Specifically, the tile size indicates a number of pixels and an aspect ratio (e.g., width and height) of the media content to be fed into the upscaling model to generate a high-resolution content output. As described further below, finding an optimal input tile size for the upscaling model is important to increase efficiency and performance of the upscaling model while reducing the memory and latency consumptions.

The input tile size affects how much details can be captured by the upscaling model. For example, a larger tile size may capture more fine-grained details in the low-resolution content, which can help in generating a more accurate high-resolution output, thereby increasing accuracy and efficiency of the upscaling model. However, the larger tile size generally leads to higher computational complexity, which may require more memory, processing power, and time, thereby potentially increasing latency and higher memory requirement. Additionally, an upscaling model for a larger tile size may be slower to train and deploy because (i) each training run during training takes longer since a larger tile size generally means a larger model and (ii) a larger dataset may be needed to effectively train an upscaling model. This is because the upscaling model needs to learn various features and patterns at different scales. Moreover, the architecture of the upscaling model may be affected by the input tile size. For larger tile sizes, the number of layers, filters, and other architectural parameters may need to be adjusted to maintain a suitable balance between complexity and performance.

In other words, the larger tile sizes allow the upscaling model to capture more contextual information from the input content. However, striking a balance between capturing enough contextual information and maintaining spatial details is important. For example, if the goal is to use the upscaling model for real-time applications, such as video processing, a balance between input size and computational efficiency is crucial. Larger input sizes might lead to slower inference times. As such, the specific requirements of designed application is carefully considered to find the optimal balance for specific use case.

Once the receiver 120 converts all the tiles of the media content using the upscaling model, the upscaled media content is then rendered on the visual display 130 in accordance with a resolution and an aspect ratio of a visual display.

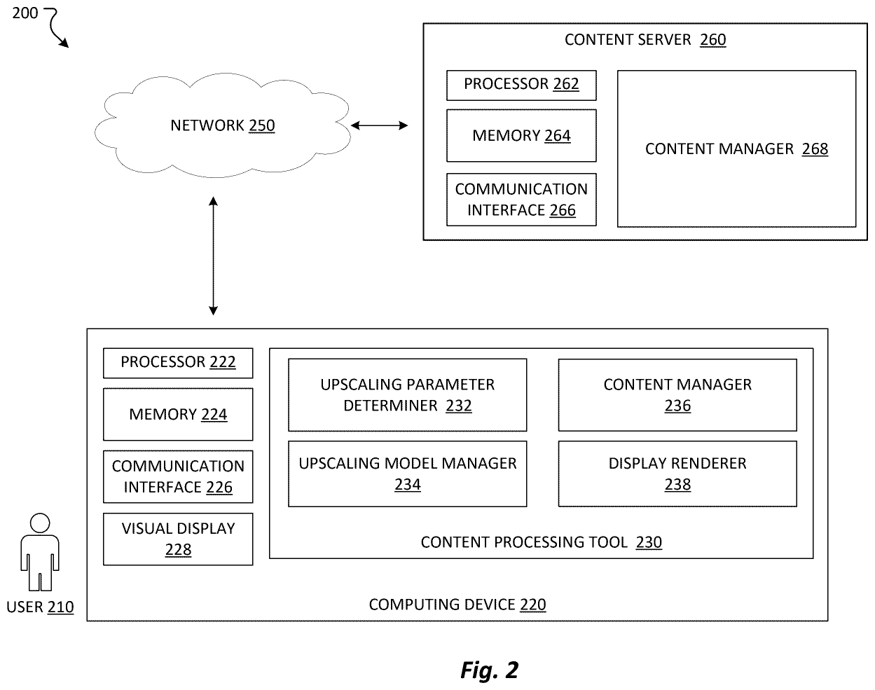

Referring now to FIG. 2, a block diagram of an example of an operating environment 200 in which a content processing tool may be implemented in accordance with examples of the present disclosure is provided. To do so, the operating environment 200 includes a computing device 220 associated with the user 210. The computing device 220 may be, but is not limited to, a computer, a notebook, a laptop, a mobile device, a smartphone, a smart TV, a smart monitor, a tablet, a portable device, a wearable device, or any other suitable computing device that is capable of executing the content processing tool 230. The operating environment 200 may further include one or more remote devices, such as a content server 260, that are communicatively coupled to the computing device 220 via a network 250. The network 250 may include any kind of computing network including, without limitation, a wired or wireless local area network (LAN), a wired or wireless wide area network (WAN), and/or the Internet.

The computing device 220 includes a content processing tool 230 executing on a computing device 220 having a processor 222, a memory 224, and a communication interface 226. Specifically, the content processing tool 230 is communicatively coupled to a visual display 228 that is communicatively coupled to the computing device 220 to display media content in accordance with a resolution and an aspect ratio of a visual display. For example, the media content may be one or more images, pictures, photos, videos, and/or audios.

The content processing tool 230 is configured to increase a resolution of media content received from the content server 260 using an upscaling model to be displayed in accordance with a resolution and an aspect ratio of the visual display 228. Specifically, the content processing tool 230 is configured to achieve increased efficiency and performance of the upscaling model while reducing latency and memory consumption in a display pipeline. To do so, the content processing tool 230 includes an upscaling parameter determiner 232, an upscaling model manager 234, a content manager 236, and a display renderer 238.

The upscaling parameter determiner 232 is configured to determine an input resolution of a content based on the output display resolution of the visual display and an upscaling factor. The input resolution of the content indicates a resolution of the media content to be inputted or fed into an upscaling model. To do so, the upscaling parameter determiner 232 determines an output display resolution of the visual display. For example, when the visual display is detected, the upscaling parameter determiner 232 may automatically select a highest resolution or a recommended resolution indicated by a system of the computing device. Alternatively, the upscaling parameter determiner 232 may receive an input indicative of the output display resolution selected by a user 210. For example, if the output display resolution of the visual display is 2560×1440 pixels and the upscaling factor is 4, the upscaling parameter determiner 232 determines that the input resolution should be 1280×720 pixels.

Additionally, the upscaling parameter determiner 232 is configured to determine an upscaling factor. The upscaling factor indicates how much the original content from the content server 260 is to be upscaled. For example, if the upscaling factor is 4, a resolution of an output content will be four times higher than a resolution of an input content. The upscaling factor may be selected by and received from the user 210. Alternatively, the upscaling factor may be determined based on the output display resolution and an application to be used to render the content on the visual display. In some embodiments, a machine learning model may be used to determine the upscaling factor based on, for example, the output display resolution of the visual display and/or a type of media content to be displayed.

The upscaling model manager 234 is configured to determine an optimal size of an input tile of an upscaling model to be used to upscale the media content based on parameters. To do so, the upscaling model manager 234 is configured to determine an optimal balance between efficiency and performance of the upscaling model and the memory and latency consumptions based on one or more parameters. For example, the parameters include, but not limited to, a size of a decoder output macroblock, a session configuration (e.g., real-time application), an input frame resolution, system limitations (e.g., memory and latency), and memory and latency requirements, and performance of available upscaling models (e.g., training variables).

As described above, the tile size affects how much details can be captured by the upscaling model. For example, a larger tile size may capture more fine-grained details in the low-resolution content, which can help in generating a more accurate high-resolution output, thereby increasing accuracy and efficiency of the upscaling model. However, the larger tile size generally leads to higher computational complexity, which may require more memory, processing power, and time, thereby potentially increasing latency and higher memory requirement. Additionally, an upscaling model for a larger tile size may be slower to train and deploy because (i) each training run during training takes longer since a larger tile size generally means a larger model and (ii) a larger dataset may be needed to effectively train an upscaling model. This is because the upscaling model needs to learn various features and patterns at different scales. Moreover, the architecture of the upscaling model may be affected by the input tile size. For larger tile sizes, the number of layers, filters, and other architectural parameters may need to be adjusted to maintain a suitable balance between complexity and performance.

In other words, the larger tile sizes allow the upscaling model to capture more contextual information from the input content. However, striking a balance between capturing enough contextual information and maintaining spatial details is important. For example, if the goal is to use the upscaling model for real-time applications, such as video processing, a balance between input size and computational efficiency is crucial. Larger input sizes might lead to slower inference times. As such, the specific requirements of designed application is carefully considered to find the optimal balance for specific use case.

Additionally, the upscaling model manager 234 is further configured to select an upscaling model from a plurality of upscaling models to be used for upscaling the media content based on the tile size and the upscaling factor. Each upscaling model is trained for a particular tile size and an upscaling factor. For example, the upscaling model is a deep neural network (DNN), a convolutional neural network (CNN), a deep convolutional neural networks (DCNN), other type of machine learning models, or a combination of models. In other words, each upscaling model is associated with a fixed size of input and output. For example, the upscaling parameter determiner 232 may determine that an input media content is to be rendered on a QHD visual display monitor with an output display resolution of 2560×1440 pixels by using an upscaling model to increase the resolution of the input media content by 4× using a 56×224 tile size. In such an example, the upscaling model manager 234 is configured to select an upscaling model that was trained using a 56×224 tile size and a 4× upscaling factor.

The content manager 236 is configured to receive media content from the content server 260 and decode the media content. Specifically, the content manager 236 is configured to transmits a request to the content server 260 to receive the media content according to the input resolution determined by the upscaling parameter determiner 232. In other words, the content manager 236 controls the input resolution of the media content to be received from the content server 260. As described above, the received media content is fragmented and encoded at the content server 260 to reduce memory storage consumption and transmission latency.

Once the requested media content is received from the content server 260, the content manager 236 is further configured to decode the media content, output macroblocks of content, and store the macroblocks in a memory region rendered for a buffer, which are then fed into an upscaling model tile-by-tile to upscale the content to be displayed on the visual display 228. In some embodiments, the received media content may further be encrypted by the content server 260. In such embodiments, the content manager 236 is configured to further decrypt the encrypted compressed content and decompress the decrypted compressed content into macroblocks of decompressed content. However, in certain embodiments, the content server 260 may first encrypt the content and compress the encrypted content. In such embodiments, the content manager 236 is configured to decompress then decrypt the decompressed encrypted content into macroblocks.

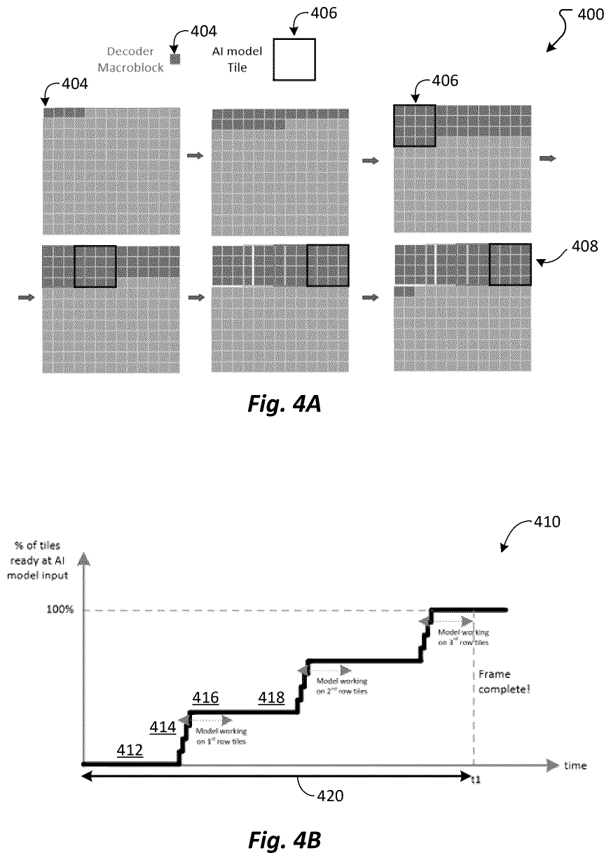

The content manager 236 is further configured to determine if a sufficient number of macroblocks is decoded and stored to form a row of tiles of content. Since the macroblocks are generated in a row-major order, the content manager 236 is configured to determine whether a total number of rows of macroblocks is equal to a height of a defined tile in order to feed the row of tiles into the upscaling model to being processing the row of tiles. It should be noted that while the upscaling model is configured to process each tile-by-tile, the upscaling model waits for a single row of tiles to be generated to being processing a first tile of the row of tiles, as described further in FIGS. 4-6. In other words, there is an idle time period where the upscaling model waits for a row of tiles to be generated and stored in the buffer memory between the content manager 236 and the upscaling model. However, it should be appreciated that, in some embodiments, the content manager 236 may not wait until a row of tiles has been generated. Instead, the content manager 236 may start converting the content once a sufficient number of macroblocks is decoded to form a single tile. For example, if the buffer memory allows simultaneous read and write, the content manager 236 may start reading and converting a tile of content from the buffer memory while macroblocks are continued to be decoded and written in the buffer memory.

For example, in order to reserve power on DRAM memory accesses, the input tiles of the upscaling model are typically stored in an on-chip SRAM memory, which often has superior power efficiency than the off-chip DRAM. SRAM memory stores any tiles that were not yet processed by the upscaling model. Therefore, the memory size required is approximately one row of tiles. The content manager 236 is configured to write one macroblock after the other to the SRAM memory until enough input tiles are generated for the upscaling model to begin processing the input tiles. In the illustrative embodiment, a double buffer is used so that the decoder can continue to write new macroblock while the upscaling model fetches input tiles. As such, as described further below, changing the input tile size may reduce latency and memory consumption.

The display renderer 238 is configured to display the upscaled media content in accordance with a resolution and an aspect ratio of the visual display 228. Once the entire content has been converted using the upscaling model, the display renderer 238 is configured to render the display of the upscaled media content on the visual display 228 in accordance with a resolution and an aspect ratio of the visual display 228.

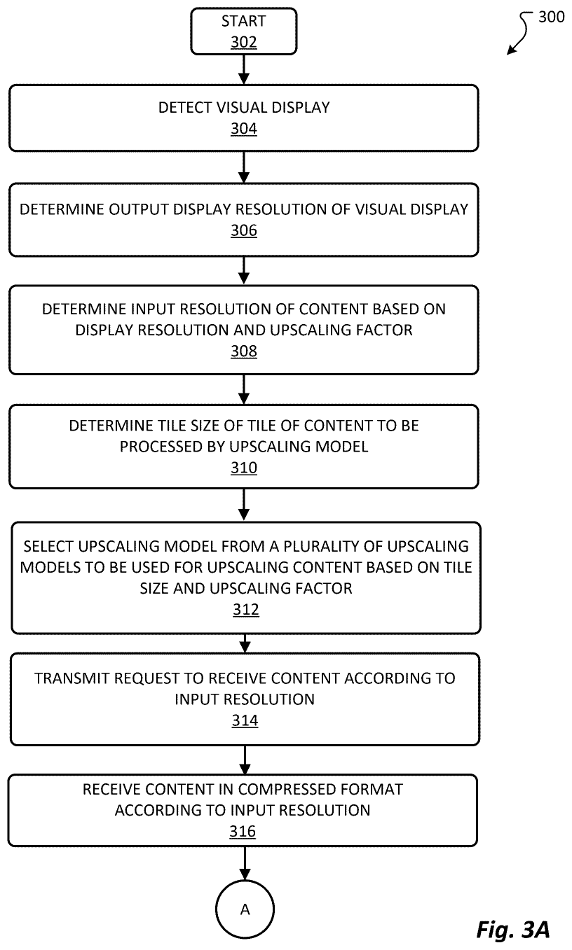

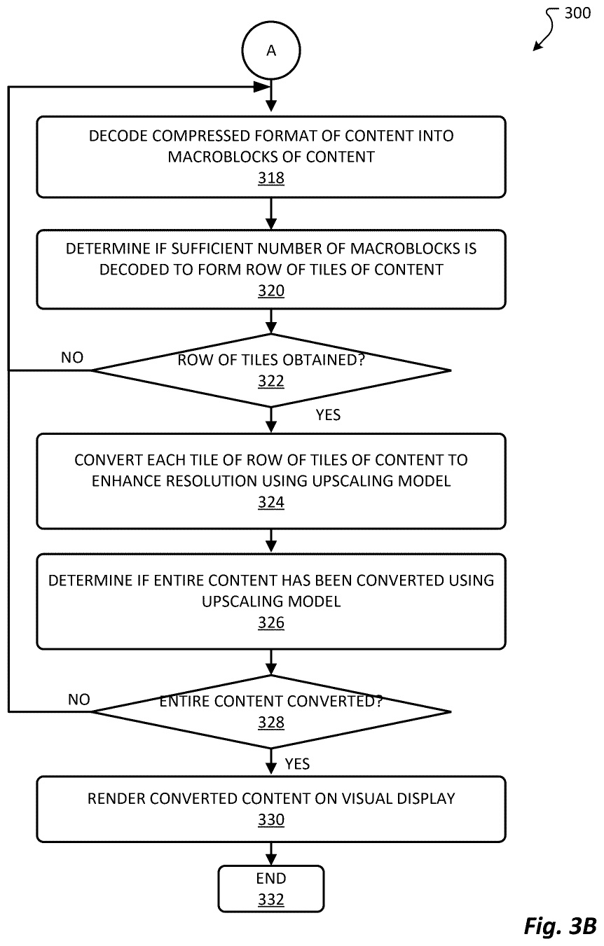

Referring now to FIGS. 3A and 3B, a method 300 for upscaling media content using an upscaling model in accordance with examples of the present disclosure is provided. A general order for the steps of the method 300 is shown in FIGS. 3A and 3B. Generally, the method 300 starts at 302 and ends at 332. The method 300 may include more or fewer steps or may arrange the order of the steps differently than those shown in FIGS. 3A and 3B. In the illustrative aspect, the method 300 is performed by a computing device (e.g., a user device 220) of a user 210. However, it should be appreciated that one or more steps of the method 300 may be performed by another device (e.g., a server 160).

Specifically, in some aspects, the method 300 may be performed by a content processing tool (e.g., 230) executed on the user device 220. For example, the content processing tool 230 is executed on the computing device 220 and is communicatively coupled to a visual display (e.g., 228) that has content displaying functionalities. For example, the computing device 220 may be, but is not limited to, a computer, a notebook, a laptop, a mobile device, a smartphone, a tablet, a portable device, a wearable device, or any other suitable computing device that is capable of executing a content processing tool (e.g., 230). For example, the server 260 may be any suitable computing device that is capable of communicating with the computing device 220. The method 300 can be executed as a set of computer-executable instructions executed by a computer system and encoded or stored on a computer readable medium. Further, the method 300 can be performed by gates or circuits associated with a processor, Application Specific Integrated Circuit (ASIC), a field programmable gate array (FPGA), a system on chip (SOC), or other hardware device. Hereinafter, the method 300 shall be explained with reference to the systems, components, modules, software, data structures, user interfaces, etc. described in conjunction with FIGS. 1, 2, and 7-9.

The method 300 starts at operation 302, where flow may proceed to 304. At operation 304, the content processing tool 230 detects a visual display (e.g., 228) that is communicatively coupled to a computing device (e.g., 220) that is executing the content processing tool 230. For example, the content processing tool 230 may detect a visual display in response to being wirelessly or wiredly connected to the computing device.

At operation 306, the content processing tool 230 determines an output display resolution of the visual display. For example, when the visual display is detected, the content processing tool 230 may automatically select a highest resolution or a recommended resolution indicated by a system of the computing device. Alternatively, the content processing tool 230 may receive an input indicative of the output display resolution selected by a user.

At operation 308, the content processing tool 230 determines an input resolution of a content based on the output display resolution of the visual display and an upscaling factor. The upscaling factor indicates how much the original content from the content server is to be upscaled. For example, if the upscaling factor is 4, a resolution of an output content will be four times higher than a resolution of an input content. The upscaling factor may be selected by and received from the user. For example, the upscaling factor may be part of a system configuration. The user may select it from pre-defined values, depending on which upscaling models are supported. In some embodiments, an on/off option may be available if the upscaling models support a single scaling factor. More options may be available if the upscaling models support different scaling factors.

Alternatively, in some embodiments, the upscaling factor may be determined based on the output display resolution and an application to be used to render the content on the visual display. In some embodiments, a machine learning model may be used to determine the upscaling factor.

The input resolution of the content indicates a resolution of the content to be inputted or fed into an upscaling model. As described further below, once the input resolution of the content is determined, the content processing tool 230 sends a request to a content server (e.g., 110, 260) to receive the content according to the input resolution. For example, if the output display resolution of the visual display is 2560×1440 pixels and the upscaling factor is 4, the upscaling parameter determiner 232 determines that the input resolution should be 1280×720 pixels.

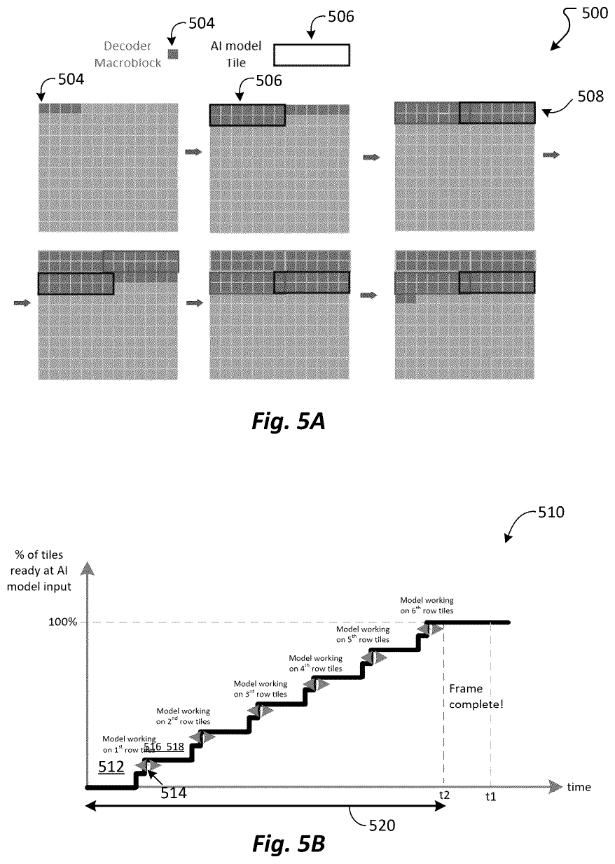

At operation 310, the content processing tool 230 determines a tile size of a tile of the content to be processed by the upscaling model. The tile is a segment of the content to be inputted and processed by the upscaling model. Specifically, the tile size indicates a number of pixels and an aspect ratio (e.g., width and height) of the media content to be fed into the upscaling model to generate a high-resolution content output. For example, according to the illustrative embodiment shown in FIG. 5A, the tile has a shape of an elongated rectangle, such that a width of the tile is greater than a height of the tile.

To determine the tile size, the content processing tool 230 is configured to determine an optimal balance between performance of the upscaling model and the memory and latency consumptions based on parameters. For example, the parameters include, but not limited to, a size of a decoder output macroblock, a session configuration (e.g., real-time application), an input frame resolution, system limitations (e.g., memory and latency), and memory and latency requirements, and performance of available upscaling models (e.g., training variables).

The tile size affects how much details can be captured by the upscaling model. For example, a larger tile size may capture more fine-grained details in the low-resolution content, which can help in generating a more accurate high-resolution output, thereby increasing accuracy and efficiency of the upscaling model. However, the larger tile size generally leads to higher computational complexity, which may require more memory, processing power, and time, thereby potentially increasing latency and higher memory requirement. Additionally, an upscaling model for a larger tile size may be slower to train and deploy because (i) each training run during training takes longer since a larger tile size generally means a larger model and (ii) a larger dataset may be needed to effectively train an upscaling model. Moreover, the architecture of the upscaling model may be affected by the input tile size. For larger tile sizes, the number of layers, filters, and other architectural parameters may need to be adjusted to maintain a suitable balance between complexity and performance.

In other words, the larger tile sizes allow the upscaling model to capture more contextual information from the input content. However, striking a balance between capturing enough contextual information and maintaining spatial details is important. For example, if the goal is to use the upscaling model for real-time applications, such as video processing, a balance between input size and computational efficiency is crucial. Larger input sizes might lead to slower inference times. As such, the specific requirements of designed application is carefully considered to find the optimal balance for specific use case.

At operation 312, the content processing tool 230 selects the upscaling model from a plurality of upscaling models to be used for upscaling the content based on the tile size and the upscaling factor. Each upscaling model is trained for a particular tile size and an upscaling factor. In other words, each upscaling model is associated with a fixed size of input and output. For example, the content processing tool 230 may determine that an input media content is to be rendered on a QHD visual display monitor with an output display resolution of 2560×1440 pixels by using an upscaling model to increase the resolution of the input media content by 4× using a 56×224 tile size. In such an example, the content processing tool 230 is configured to select an upscaling model that was trained using a 56×224 tile size and a 4× upscaling factor.

At operation 314, the content processing tool 230 transmits a request to the content server to receive the content according to the input resolution. In other words, the content processing tool 230 determines the input resolution of the content to be received from the content server.

At operation 316, the content processing tool 230 receives the content in a compressed format according to the input resolution. Subsequently, the method 300 advances to operation 318 in FIG. 3B.

At operation 318, the content processing tool 230 decodes the received content into macroblocks of content. As described above, the content is fragmented and encoded at the content server 260 to reduce memory storage consumption and transmission latency. The content processing tool 230 receives and decompresses the compressed content and outputs macroblocks to a memory region rendered for a buffer, which are then fed into an upscaling model tile-by-tile to upscale the content to be displayed on a visual display. However, since the macroblocks are generated in a row-major order, it is not optimized for the upscaling model processing (e.g., the super resolution processing). In order for the upscaling model to begin processing a first tile, the upscaling model needs to wait for a first few lines of the macroblocks to be generated until a total number of rows of macroblocks is equal to a height of a defined tile.

It should be appreciated that, in some embodiments, the compressed content may further be encrypted by the content server 260. In such embodiments, the content processing tool 230 decrypts the encrypted compressed content and decompresses the decrypted compressed content into macroblocks of decompressed content. However, in certain embodiments, the content server 260 may first encrypt the content and compress the encrypted content. In such embodiments, the content processing tool 230 decompresses then decrypts the decompressed encrypted content into macroblocks.

At operation 320, the content processing tool 230 determines if a sufficient number of macroblocks is decoded to form a row of tiles of content. As described above, since the macroblocks are generated in a row-major order, the content processing tool 230 determines whether a total number of rows of macroblocks is equal to a height of a defined tile. In other words, there is an idle time period where the upscaling model waits for a row of tiles to be generated and stored in the buffer memory between a decoder of the content processing tool 230 and the upscaling model, which may cause latency and memory consumption.

If the content processing tool 230 determines that a row of tiles has not been generated at operation 322, the method 300 loops back to operation 318 to continue generating the macroblocks until the total number of rows of macroblocks is equal to a height of a defined tile. If, however, the content processing tool 230 determines that a row of tiles has been generated, the method 300 advances to operation 324.

At operation 324, the content processing tool 230 converts each tile of the row of tiles of content to enhance the resolution using the upscaling model selected at operation 312. For example, as shown in FIG. 5A, a single row of tiles 508 has a height of two rows of macroblocks 504 and includes two tiles. Once the row of tiles 508 is generated, each tile 506 of the row of tiles 508 is inputted or fed into upscaling model.

However, it should be appreciated that, in some embodiments, the content processing tool 230 may not wait until a row of tiles has been generated. Instead, the content processing tool 230 may start converting the content once a sufficient number of macroblocks is decoded to form a single tile. For example, if the buffer memory allows simultaneous read and write (e.g., a single SRAM buffer), the content processing tool 230 may start reading and converting a tile of content from the buffer memory while macroblocks are continued to be decoded and written in the buffer memory.

At operation 326, the content processing tool 230 determines if the entire content has been converted using the upscaling model. If the content processing tool 230 determines that the entire content has not been upscaled at operation 326, the method 300 loops back to operation 318 to continue generating macroblocks of the content and converting each tile using the upscaling model. If, however, the content processing tool 230 determines that the entire content has been upscaled, the method 300 advances to operation 330.

At operation 330, the content processing tool 230 renders the converted content on the visual display. Subsequently, the method 300 may end at operation 332.

Referring now to FIGS. 4-6, block diagrams and graphs illustrate how a size of an input tile for an upscaling model affects processing time of media content to be displayed on a visual display. The input tile is a rectangular crop of the media content (e.g., an image, a frame of a video, etc.) to be inputted and processed by the upscaling model. Specifically, the tile size indicates a number of pixels and an aspect ratio (e.g., width and height) of the media content to be fed into the upscaling model to generate a high-resolution content output. As described further below, finding an optimal input tile size for the upscaling model is important to increase efficiency and performance of the upscaling model while reducing the memory and latency consumptions.

As described above, the size of an input tile is different from the size of a macroblock. Since the macroblocks are generated in a row-major order, rows of the macroblocks are conducted in lines (e.g., the macroblocks of a first line are ready, then the second line, and so on). In order for the upscaling model to begin processing a first tile, the upscaling model needs to wait for a first few lines of the macroblocks to be generated until a total number of rows of macroblocks is equal to a height of a defined tile. In other words, there is an idle time period where the upscaling model waits for each row of tiles to be generated and stored in the buffer memory between the decoder and the upscaling model, which adds latency and memory consumption. Accordingly, the content processing tool is configured to optimize an input tile size of an upscaling model to increase efficiency and performance of the upscaling model while reducing latency and memory consumption in a display pipeline. It should be appreciated that the media content is segmented into tiles with overlap to improve the upscaled image quality (e.g., avoid artifacts between tiles) and maintain the quality of the upscaling model.

FIGS. 4A and 4B illustrate upscaling of a single frame of the media content using an input tile that is a 1:1 square. For example, the input tile 406 may be 112×112 or 224×224 pixels. As illustrated in FIG. 4A, the macroblocks 404 are generated row-by-row, and the upscaling model is waiting for a first few lines of macroblocks to be generated until a first row of tiles 408 is ready for the upscaling model. In the illustrated embodiment, it takes 4 rows of macroblocks 404 to form a single row of tiles 408. Such idle period is identified as phase 412 in FIG. 4B. The graph 410 of FIG. 4B illustrates a percentage of tiles ready for the upscaling model versus processing time. After the first tile is ready, the next tiles in the same first row will be ready soon afterwards. In other words, as indicated by phase 414, all the tiles in the first row are ready for the upscaling mode as a quick burst, which occurs following the long idle time period 412.

The upscaling model converts all the tiles in the first row at phase 416 and waits for a second row of tiles to be produced at phase 418. The process repeats until all the tiles of entire rows of the media content have been converted by the upscaling model. Since there are 3 rows of tiles in this example shown in FIG. 4A, the process repeats 3 times until the upscaling model converts all tiles of the third row. Upscaling of the frame of the media content is completed at time t₁ 420 with the 1:1 input tile size.

On the other hand, FIGS. 5A and 5B illustrate upscaling of a single frame of the media content using an input tile that is an elongated rectangle, such that a width of the tile is greater than a height of the tile (e.g., 2:7 oblong). For example, the input tile 506 may be 56×224 pixels. As illustrated in FIG. 5A, the macroblocks 404 are generated row-by-row, and the upscaling model is waiting for a first few lines of macroblocks to be generated until a first row of tiles 508 is ready for the upscaling model. In the illustrated embodiment, it takes 2 rows of macroblocks 504 to form a single row of tiles 508. Such idle period is identified as phase 512 in FIG. 5B. The graph 510 of FIG. 5B illustrates a percentage of tiles ready for the upscaling model versus processing time. After the first tile is ready, the next tiles in the same first row will be ready soon afterwards. In other words, as indicated by phase 514, all the tiles in the first row are ready for the upscaling mode as a quick burst, which occurs following the long idle time period 512.

The upscaling model converts all the tiles in the first row at phase 516 and waits for a second row of tiles to be produced at phase 518. The process repeats until all the tiles of entire rows of the media content have been converted by the upscaling model. Since there are 6 rows of tiles in this example shown in FIG. 5A, the process repeats 6 times until the upscaling model converts all tiles of the third row.

By changing the input tile size to an elongated rectangle, the tiles 506 are ready for the upscaling model earlier and the upscaling model needs less tiles ready to work until the next row is ready. As such, upscaling of the frame of the media content is completed at time t₂ 520 with the 2:7 input tile size. As can be seen in FIG. 5B, the processing time t₂ 520 is shorter than the processing time t₁ 420 with the 1:1 input tile size. While the total number of tile rows is larger due to the smaller tile height and the bigger tile width, each row is made up of fewer tiles and, therefore, takes less time to process. In other words, changing the input tile size reduces the delays between the tile rows and thereby reducing the overall processing time of the media content.

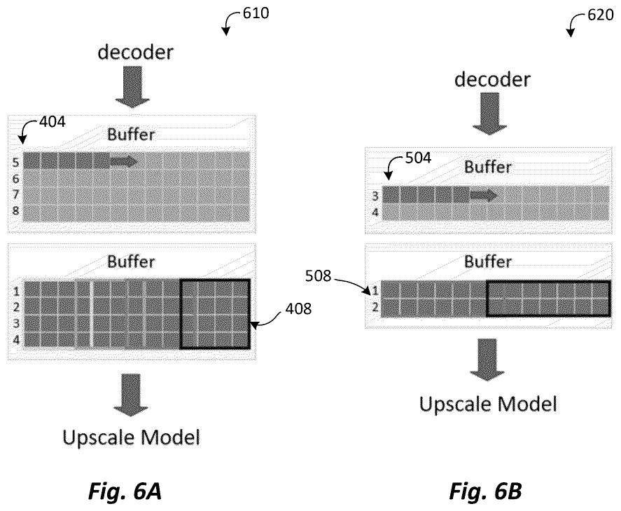

Additionally, as illustrated in FIGS. 6A and 6B, adjusting the input tile size also reduces memory needed for the buffer between a decoder of the content processing tool 230 and the upscaling model. In order to reserve power on DRAM memory accesses, the input tiles of the upscaling model are typically stored in an on-chip SRAM memory, which often has superior power efficiency than the off-chip DRAM. SRAM memory stores any tiles that were not yet processed by the upscaling model. Therefore, the memory size required is approximately one row of tiles. The decoder of the content processing tool 230 is configured to write one macroblock after the other to the SRAM memory until enough input tiles are generated for the upscaling model to begin processing the input tiles. In the illustrative embodiment, a double buffer is used so that the decoder can continue to write new macroblock while the upscaling model fetches input tiles. Accordingly, when the aspect ratio of the input tile is changed to an elongated rectangle as described above, each buffer is required to hold less memory as the tile row is narrower and is made up of fewer tiles.

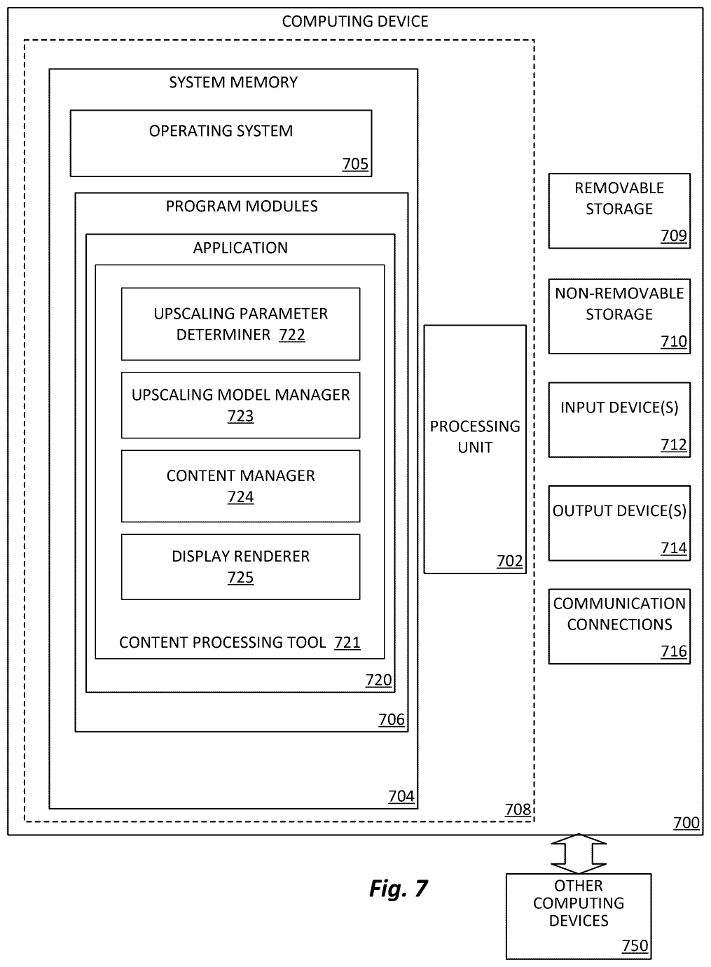

FIGS. 7-9 and the associated descriptions provide a discussion of a variety of operating environments in which aspects of the disclosure may be practiced. However, the devices and systems illustrated and discussed with respect to FIGS. 7-9 are for purposes of example and illustration and are not limiting of a vast number of computing device configurations that may be utilized for practicing aspects of the disclosure, described herein.

FIG. 7 is a block diagram illustrating physical components (e.g., hardware) of a computing device 700 with which aspects of the disclosure may be practiced. The computing device components described below may be suitable for the computing devices described above, including one or more devices associated with machine learning service (e.g., content server 260), as well as computing device 240 discussed above with respect to FIG. 2. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories.

The system memory 704 may include an operating system 705 and one or more program modules 706 suitable for running software application 720, such as one or more components supported by the systems described herein. As examples, system memory 704 may store a content processing tool 721, including an upscaling parameter determiner 722, an upscaling model manager 723, a content manager 724, and/or a display renderer 725. The operating system 705, for example, may be suitable for controlling the operation of the computing device 700.

Furthermore, aspects of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., application 720) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

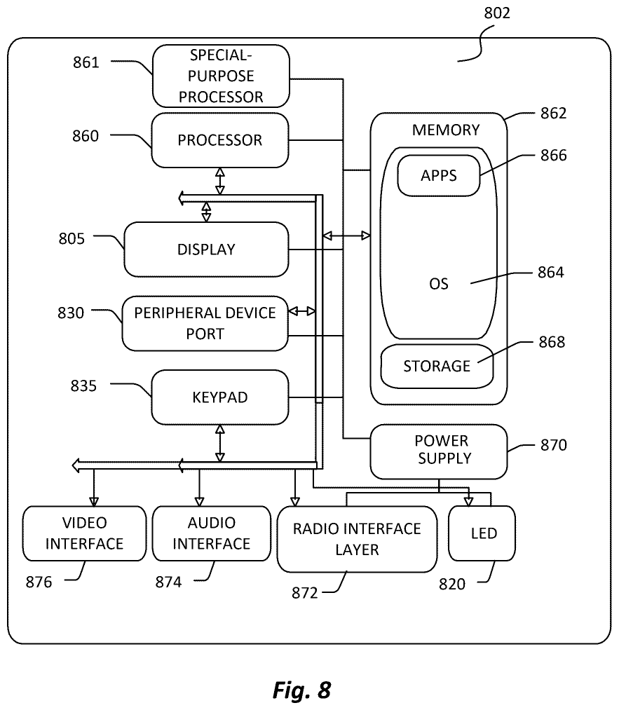

FIG. 8 illustrates a system 800 that may, for example, be a mobile computing device, such as a mobile telephone, a smart phone, wearable computer (such as a smart watch), a tablet computer, a laptop computer, and the like, with which aspects of the disclosure may be practiced. In one example, the system 800 is implemented as a “smart phone” capable of running one or more applications (e.g., browser, e-mail, calendaring, contact managers, messaging clients, games, and media clients/players). In some aspects, the system 800 is integrated as a computing device, such as an integrated personal digital assistant (PDA) and wireless phone.

In a basic configuration, such a mobile computing device is a handheld computer having both input elements and output elements. The system 800 typically includes a display 805 and one or more input buttons that allow the user to enter information into the system 800. The display 805 may also function as an input device (e.g., a touch screen display).

If included, an optional side input element allows further user input. For example, the side input element may be a rotary switch, a button, or any other type of manual input element. In alternative aspects, system 800 may incorporate more or less input elements. For example, the display 805 may not be a touch screen in some aspects. In another example, an optional keypad 835 may also be included, which may be a physical keypad or a “soft” keypad generated on the touch screen display.

In various aspects, the output elements include the display 805 for showing a graphical user interface (GUI), a visual indicator (e.g., a light emitting diode 820), and/or an audio transducer 825 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 800 also includes a non-volatile storage area 868 within the memory 862. The non-volatile storage area 868 may be used to store persistent information that should not be lost if the system 800 is powered down. The application programs 866 may use and store information in the non-volatile storage area 868, such as e-mail or other messages used by an e-mail application, and the like. A synchronization application (not shown) also resides on the system 800 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the system 800 described herein (e.g., a content capture manager, a content transformer, etc.).

The system 800 has a power supply 870, which may be implemented as one or more batteries. The power supply 870 might further include an external power source, such as an AC adapter or a powered docking cradle that supplements or recharges the batteries.

The system 800 may also include a radio interface layer 872 that performs the function of transmitting and receiving radio frequency communications. The radio interface layer 872 facilitates wireless connectivity between the system 800 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated example, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 800 may further include a video interface 876 that enables an operation of an on-board camera 830 to record still images, video stream, and the like.

It will be appreciated that system 800 may have additional features or functionality. For example, system 800 may also include additional data storage devices (removable and/or non-removable) such as, magnetic disks, optical disks, or tape. Such additional storage is illustrated in FIG. 8 by the non-volatile storage area 868.

Data/information generated or captured and stored via the system 800 may be stored locally, as described above, or the data may be stored on any number of storage media that may be accessed by the device via the radio interface layer 872 or via a wired connection between the system 800 and a separate computing device associated with the system 800, for example, a server computer in a distributed computing network, such as the Internet. As should be appreciated, such data/information may be accessed via the radio interface layer 872 or via a distributed computing network. Similarly, such data/information may be readily transferred between computing devices for storage and use according to any of a variety of data/information transfer and storage means, including electronic mail and collaborative data/information sharing systems.

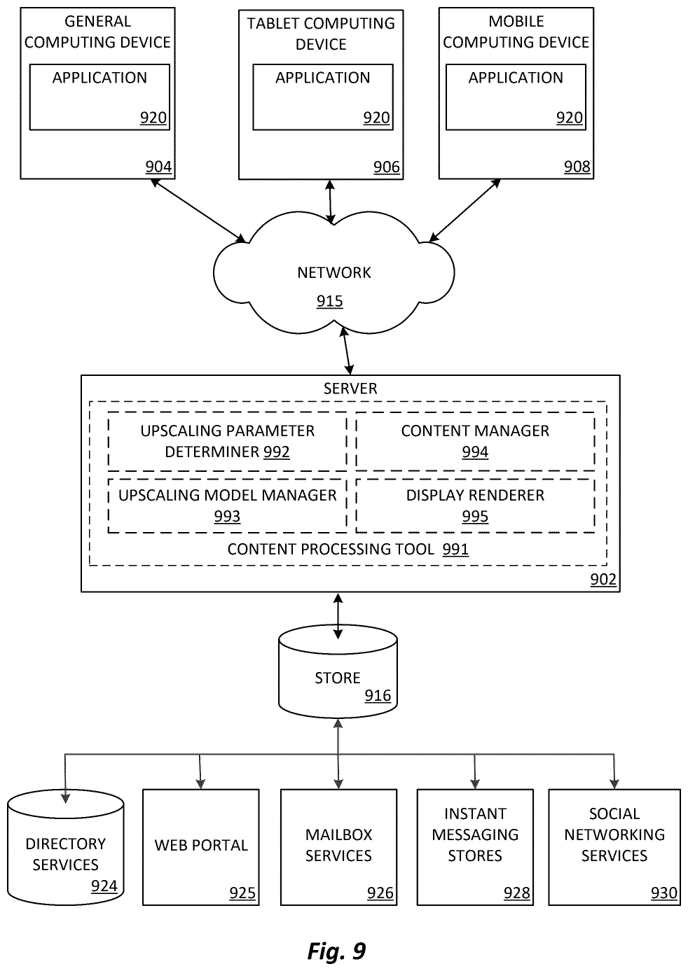

FIG. 9 illustrates one aspect of the architecture of a system for processing data received at a computing system from a remote source, such as a personal computer 904, tablet computing device 906, or mobile computing device 908, as described above. Content displayed at server device 902 may be stored in different communication channels or other storage types. For example, various documents may be stored using a directory service 924, a web portal 925, a mailbox service 926, an instant messaging store 928, or a social networking site 930.

An application 920 (e.g., similar to the application 720) may be employed by a client that communicates with server device 902. Additionally, or alternatively, a content processing tool 991, including an upscaling parameter determiner 992, an upscaling model manager 993, a content manager 994, and/or a display renderer 995 may be employed by server device 902. The server device 902 may provide data to and from a client computing device such as a personal computer 904, a tablet computing device 906 and/or a mobile computing device 908 (e.g., a smart phone) through a network 915. By way of example, the computer system described above may be embodied in a personal computer 904, a tablet computing device 906 and/or a mobile computing device 908 (e.g., a smart phone). Any of these examples of the computing devices may obtain content from the store 916, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The example systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the example aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects. Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Example hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

In accordance with at least one example of the present disclosure, a method for upscaling a content using an upscaling model is provided. The method may include determining an output display resolution of a visual display adapted to display the content, determining an input resolution of the content to be requested based on the display resolution and an upscaling factor, and determining a tile size of a tile of the content to be processed by the upscaling model. The tile size indicates a number of pixels and an aspect ratio of the tile, and the tile is a segment of the content to be processed by the upscaling model. The method may further include selecting the upscaling model from a plurality of upscaling models to be used for upscaling the content based on the tile size and the upscaling factor, each upscaling model being trained with a particular tile size and a particular upscale factor for increasing the resolution of the content, in response to receiving the content according to the input resolution, converting the content to enhance the resolution of the content using the upscaling model, and rendering the converted content on the visual display.

In accordance with at least one aspect of the above method, the method may include where receiving the content comprises transmitting a request to receive the content according to the input resolution, receiving the content in a compressed format, and decoding the compressed format of the content into macroblocks of the content, wherein each macroblock is a segment of the content in a decompressed format.

In accordance with at least one aspect of the above method, the method may include where converting the content to enhance the resolution of the content using the upscaling model comprises upon obtaining a row of tiles of the content, converting each tile of the row of tiles to upscale the corresponding tile using the upscaling model, each tile including a plurality of macroblocks.

In accordance with at least one aspect of the above method, the method may further include storing row data of the row of tiles of the content in a memory to be used by the upscaling model to process each tile of the row of tiles.

In accordance with at least one aspect of the above method, the method may include where the upscaling model is configured to clarify, sharpen, and upscale the content without losing information and characteristics of the content.

In accordance with at least one aspect of the above method, the method may include where determining the tile size of the tile of the content to be processed by the upscaling model comprises determining the tile size of the tile of the content by considering an optimal balance between performance of the upscaling model and the memory and latency consumptions based on parameters.

In accordance with at least one aspect of the above method, the method may include where the parameters include a size of a decoder output macroblock, an input frame resolution, a session configuration, performance of the upscaling model, system limitations, and memory and latency requirements.

In accordance with at least one aspect of the above method, the method may include where the tile has a shape of an elongated rectangle, and a width of the tile is greater than a height of the tile.

In accordance with at least one aspect of the above method, the method may include where determining the output display resolution of the visual display comprises in response to detecting the visual display, automatically selecting the highest available resolution of visual display as the display resolution.

In accordance with at least one aspect of the above method, the method may include where determining the output display resolution of the visual display comprises receiving an input indicative of the output display resolution.

In accordance with at least one example of the present disclosure, a computing device for upscaling a content using an upscaling model is provided. The computing device may include a processor and a memory having a plurality of instructions stored thereon that, when executed by the processor, causes the computing device to determine an output display resolution of a visual display adapted to display the content, determine an input resolution of the content to be requested based on the display resolution and an upscaling factor, determine a tile size of a tile of the content to be processed by the upscaling model, the tile size indicating a number of pixels and an aspect ratio of the tile, and the tile being a segment of the content to be processed by the upscaling model, select the upscaling model from a plurality of upscaling models to be used for upscaling the content based on the tile size and the upscaling factor, each upscaling model being trained with a particular tile size and a particular upscale factor for increasing the resolution of the content, in response to the receipt of the content according to the input resolution, convert the content to enhance the resolution of the content using the upscaling model, and render the converted content on the visual display.

In accordance with at least one aspect of the above computing device, the computing device may include where the plurality of instructions, when executed, further cause the computing device to transmit a request to receive the content according to the input resolution, receive the content in a compressed format, and decode the compressed format of the content into macroblocks of the content, wherein each macroblock is a segment of the content in a decompressed format.

In accordance with at least one aspect of the above computing device, the computing device may include where to convert the content to enhance the resolution of the content using the upscaling model comprises to upon a row of tiles of the content is obtained, convert each tile of the row of tiles to upscale the corresponding tile using the upscaling model, each tile including a plurality of macroblocks.

In accordance with at least one aspect of the above computing device, the computing device may include where the plurality of instructions, when executed, further cause the computing device to store row data of the row of tiles of the content in a memory to be used by the upscaling model to process each tile of the row of tiles.

In accordance with at least one aspect of the above computing device, the computing device may include where the upscaling model is configured to clarify, sharpen, and upscale the content without losing information and characteristics of the content.

In accordance with at least one aspect of the above computing device, the computing device may include where to determine the tile size of the tile of the content to be processed by the upscaling model comprises to determine the tile size of the tile of the content by considering an optimal balance between performance of the upscaling model and the memory and latency consumptions based on parameters.

In accordance with at least one aspect of the above computing device, the computing device may include where the tile has a shape of an elongated rectangle, and a width of the tile is greater than a height of the tile.

In accordance with at least one example of the present disclosure, a non-transitory computer-readable medium storing instructions for upscaling a content using an upscaling model is provided. The instructions when executed by one or more processors of a computing device, cause the computing device to determine an output display resolution of a visual display adapted to display the content, determine an input resolution of the content to be requested based on the display resolution and an upscaling factor, determine a tile size of a tile of the content to be processed by the upscaling model, the tile size indicating a number of pixels and an aspect ratio of the tile, and the tile being a segment of the content to be processed by the upscaling model, select the upscaling model from a plurality of upscaling models to be used for upscaling the content based on the tile size and the upscaling factor, each upscaling model being trained with a particular tile size and a particular upscale factor for increasing the resolution of the content, in response to the receipt of the content according to the input resolution, convert the content to enhance the resolution of the content using the upscaling model, and render the converted content on the visual display.

In accordance with at least one aspect of the above non-transitory computer-readable medium, the instructions when executed by one or more processors of the computing device may further include to transmit a request to receive the content according to the input resolution, receive the content in a compressed format, and decode the compressed format of the content into macroblocks of the content, wherein each macroblock is a segment of the content in a decompressed format.

In accordance with at least one aspect of the above non-transitory computer-readable medium, the instructions when executed by one or more processors of the computing device may include where to determine the tile size of the tile of the content to be processed by the upscaling model comprises to determine the tile size of the tile of the content by considering an optimal balance between performance of the upscaling model and the memory and latency consumptions based on parameters, wherein the tile has a shape of an elongated rectangle.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

What is claimed is:

1. A method for upscaling a content using an upscaling model, the method comprising:
determining an output display resolution of a visual display adapted to display the content;
determining an input resolution of the content to be requested based on the display resolution and an upscaling factor;
determining a tile size of a tile of the content to be processed by the upscaling model, the tile size indicating a number of pixels and an aspect ratio of the tile, and the tile being a segment of the content to be processed by the upscaling model;
selecting the upscaling model from a plurality of upscaling models to be used for upscaling the content based on the tile size and the upscaling factor, each upscaling model being trained with a particular tile size and a particular upscale factor for increasing the resolution of the content;
in response to receiving the content according to the input resolution, converting the content to enhance the resolution of the content using the upscaling model; and
rendering the converted content on the visual display.

2. The method of claim 1, wherein receiving the content comprises:
transmitting a request to receive the content according to the input resolution;
receiving the content in a compressed format; and
decoding the compressed format of the content into macroblocks of the content, wherein each macroblock is a segment of the content in a decompressed format.

3. The method of claim 1, wherein converting the content to enhance the resolution of the content using the upscaling model comprises:
upon obtaining a row of tiles of the content, converting each tile of the row of tiles to upscale the corresponding tile using the upscaling model, each tile including a plurality of macroblocks.

4. The method of claim 3, further comprising storing row data of the row of tiles of the content in a memory to be used by the upscaling model to process each tile of the row of tiles.

5. The method of claim 4, wherein the upscaling model is configured to clarify, sharpen, and upscale the content without losing information and characteristics of the content.

6. The method of claim 1, wherein determining the tile size of the tile of the content to be processed by the upscaling model comprises:
determining the tile size of the tile of the content by considering an optimal balance between performance of the upscaling model and the memory and latency consumptions based on parameters.

7. The method of claim 6, wherein the parameters include a size of a decoder output macroblock, an input frame resolution, a session configuration, performance of the upscaling model, system limitations, and memory and latency requirements.

8. The method of claim 1, wherein the tile has a shape of an elongated rectangle, and a width of the tile is greater than a height of the tile.

9. The method of claim 1, wherein determining the output display resolution of the visual display comprises:
in response to detecting the visual display, automatically selecting the highest available resolution of visual display as the display resolution.

10. The method of claim 1, wherein determining the output display resolution of the visual display comprises:
receiving an input indicative of the output display resolution.

11. A computing device for upscaling a content using an upscaling model, the computing device comprising:
a processor; and
a memory having a plurality of instructions stored thereon that, when executed by the processor, causes the computing device to:
determine an output display resolution of a visual display adapted to display the content;
determine an input resolution of the content to be requested based on the display resolution and an upscaling factor;
determine a tile size of a tile of the content to be processed by the upscaling model, the tile size indicating a number of pixels and an aspect ratio of the tile, and the tile being a segment of the content to be processed by the upscaling model;
select the upscaling model from a plurality of upscaling models to be used for upscaling the content based on the tile size and the upscaling factor, each upscaling model being trained with a particular tile size and a particular upscale factor for increasing the resolution of the content;
in response to the receipt of the content according to the input resolution, convert the content to enhance the resolution of the content using the upscaling model; and
render the converted content on the visual display.

12. The computing device of claim 11, wherein the plurality of instructions, when executed, further cause the computing device to:
transmit a request to receive the content according to the input resolution;
receive the content in a compressed format; and
decode the compressed format of the content into macroblocks of the content, wherein each macroblock is a segment of the content in a decompressed format.

13. The computing device of claim 11, wherein to convert the content to enhance the resolution of the content using the upscaling model comprises to:
upon a row of tiles of the content is obtained, convert each tile of the row of tiles to upscale the corresponding tile using the upscaling model, each tile including a plurality of macroblocks.

14. The computing device of claim 13, wherein the plurality of instructions, when executed, further cause the computing device to: store row data of the row of tiles of the content in a memory to be used by the upscaling model to process each tile of the row of tiles.

15. The computing device of claim 14, wherein the upscaling model is configured to clarify, sharpen, and upscale the content without losing information and characteristics of the content.

16. The computing device of claim 11, wherein to determine the tile size of the tile of the content to be processed by the upscaling model comprises to:
determine the tile size of the tile of the content by considering an optimal balance between performance of the upscaling model and the memory and latency consumptions based on parameters.

17. The computing device of claim 11, wherein the tile has a shape of an elongated rectangle, and a width of the tile is greater than a height of the tile.

18. A computer-readable storage medium storing instructions for upscaling a content using an upscaling model, the instructions when executed by one or more processors of a computing device, cause the computing device to:
determine an output display resolution of a visual display adapted to display the content;
determine an input resolution of the content to be requested based on the display resolution and an upscaling factor;
determine a tile size of a tile of the content to be processed by the upscaling model, the tile size indicating a number of pixels and an aspect ratio of the tile, and the tile being a segment of the content to be processed by the upscaling model;
select the upscaling model from a plurality of upscaling models to be used for upscaling the content based on the tile size and the upscaling factor, each upscaling model being trained with a particular tile size and a particular upscale factor for increasing the resolution of the content;
in response to the receipt of the content according to the input resolution, convert the content to enhance the resolution of the content using the upscaling model; and
render the converted content on the visual display.

19. The computer-readable storage medium of claim 18, wherein the instructions when executed by one or more processors of a computing device, further cause the computing device to:
transmit a request to receive the content according to the input resolution;
receive the content in a compressed format; and
decode the compressed format of the content into macroblocks of the content, wherein each macroblock is a segment of the content in a decompressed format.

20. The computer-readable storage medium of claim 18, wherein to determine the tile size of the tile of the content to be processed by the upscaling model comprises to:
determine the tile size of the tile of the content by considering an optimal balance between performance of the upscaling model and the memory and latency consumptions based on parameters, wherein the tile has a shape of an elongated rectangle.
